(19) United States
(12) Patent Application Publication
(10) Pub. No.: US 2016/0139762 A1
(43) Pub. Date: May 19, 2016

(54) ALIGNING GAZE AND POINTING DIRECTIONS

(71) Applicant: INUITIVE LTD., Ra'anana (IL)

(72) Inventor: Noam MEIR, Herzliya (IL)

(21) Appl. No.: 14/898,750

(22) PCT Filed: Jun. 12, 2014
(86) PCT No.: PCT/IL2014/050531

§ 371 Date: Dec. 16, 2015

Related U.S. Application Data
(60) Provisional application No. 61/841,454, filed on Jul. 1, 2013.

(51) Int. Cl. G06F 3/0487; G06K 9/62; G06K 9/00; G06F 3/01; G06F 3/00

(52) U.S. Cl. CPC G06F 3/0487; G06F 3/013; G06F 3/005; G06K 9/00288; G06K 9/00228; G06F 3/017; G06K 9/6202

(57) ABSTRACT

A system is provided herein, comprising a gaze tracking device arranged to detect a direction of a user's gaze; a three dimensional (3D) imaging device arranged to identify a user's pointing finger and a corresponding finger pointing direction; and a processor arranged to compare the detected gaze direction and the identified pointing direction and indicate an alignment therebetween. The system provides a natural user interface which may be used to interact with virtual or actual objects as well as facilitate interaction between communicating users.

### FIELD OF THE INVENTION

The present invention relates to the field of natural user interfaces, and more particularly, to a pointing interface.

### BACKGROUND OF THE INVENTION

Natural user interface (NUI) has become very popular in recent years with the introduction of true experience computer games and sophisticated consumer electronic goods. NUIs extend user experience beyond touch displays, as the latter require actual contact with the display and do not distinguish contacts by different users.

### SUMMARY OF THE INVENTION

One embodiment of the present invention provides a system comprising: a gaze tracking device arranged to detect a direction of a user's gaze; a three dimensional (3D) imaging device arranged to identify a user's pointing finger and a corresponding finger pointing direction; and a processor arranged to compare the detected gaze direction and the identified pointing direction and indicate an alignment there between.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram of a system according to some embodiments of the invention; and

FIG. 2 is a high level flowchart illustrating a method, according to some embodiments of the invention.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The following systems and methods provide a natural user interface (NUI) which may be used to interact with virtual or actual objects as well as facilitate interaction between communicating users. The NUI is exemplified in the following in two non-limiting embodiments—as a generalized system for 3D pointing recognition which identifies alignment of gazing and pointing direction, and as a system for highlighting real or virtual objects remotely that uses the for 3D pointing recognition. In both cases the system may distinguish among users and among pointing gestures.

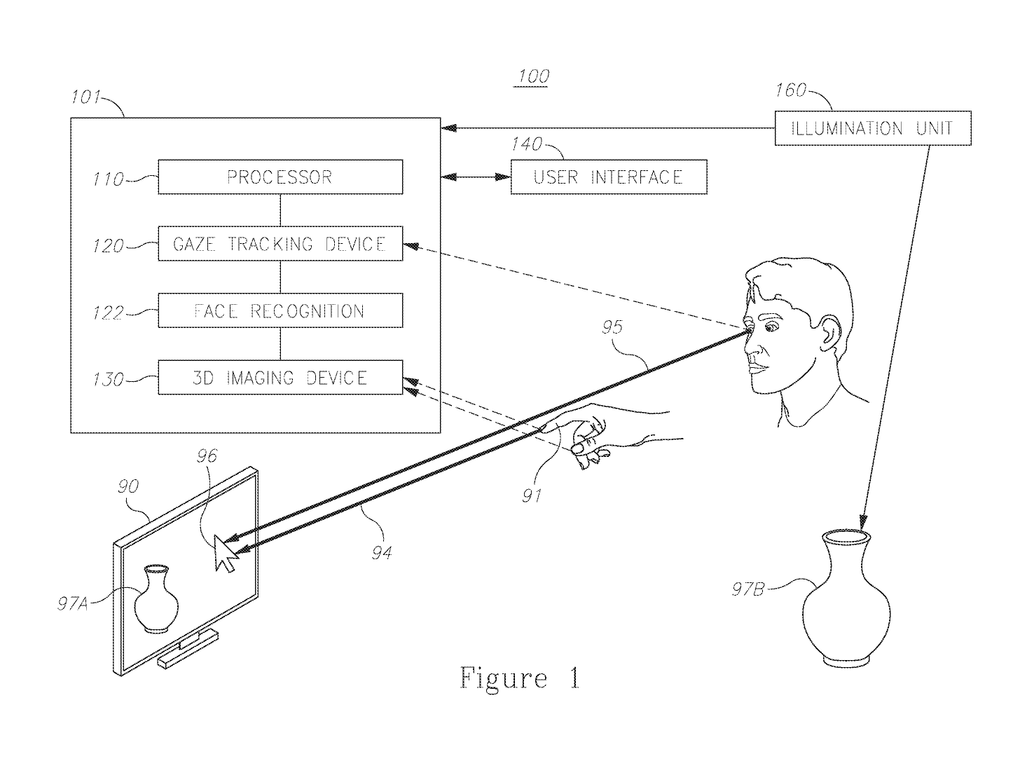

FIG. 1 is a high level schematic block diagram of a system 100 according to some embodiments of the invention.

System 100 comprises a processing unit 101 comprising a processor 110 connected to a gaze tracking device 120 and to 3D imaging device 130. Elements of system 100 and processing unit 101 may be interconnected directly or over communication links (not shown).

Gaze tracking device 120 is arranged to track a gaze 95 of a user and detect the direction of gaze 95. For example, gaze tracking device 120 may track the positions of the user's eye pupils and calculate the global geometry of user gaze vector 95.

In embodiments, processing unit 101 or system 100 may further comprise a face recognition module 122 arranged to recognize different users and differentiate between their respective gazes 95.

3D imaging device 130 is arranged to image user's fingers and identify a user's pointing finger 91. 3D imaging device 130 is further arranged to calculate the direction of finger pointing 94. For example, 3D imaging device 130 may be a stereo imaging device (e.g. using visible light or infrared (IR) cameras) that provides 3D information on the user position and the user's hand location and fingertip positions. It may track the fingertips locations and their relative locations to each other. By this, 3D imaging device 130 may identify pointing finger(s) and their pointing direction in space. In some embodiments, an event of pointing is detected when that the tip of the finger that is detected by the 3D imaging 130 is on the line of sight that is detected by the gaze tracking.

In embodiments, 3D imaging device 130 may comprise dedicated cameras for generating a depth map of the scene and a controlling camera which relays and optionally processes the images from the depth mapping cameras. In embodiments, the dedicated depth mapping cameras may comprise IR cameras or sensors, and 3D imaging device 130 may further comprise IR illuminators (e.g. LEDs, e.g. arrayed) for illuminating the scene and assisting the formation of the depth map. In embodiments, 3D imaging device 130 may comprise or be enhanced by an audio source and an array of microphones implementing phased array audio beam steering to generate or enhance the depth map.

Processor 110 is arranged to compare the detected gaze direction and the identified pointing direction and to indicate an alignment between the two directions, with respect to a specified tolerance range or threshold. Both direction of finger pointing 94 and direction of gaze 95 may be calculated and represented using different coordination systems and under specified accuracy requirements.

In embodiments, system 100 further comprises a user interface 140 which is activated by the identified gaze direction, by the identified finger pointing direction or by any combination thereof. For example, user interface 140 may operate with respect to a display 90 and further control a displayed element 96 such as a cursor. Generally, user interface 140 is arranged to use at least one of the detected gaze direction and the identified finger pointing direction to interact with the user.

For example, user interface 140 may perform any specified operation that relates to a pointing activity and element 96 on display 90, such as a selection operation of an icon as element 96.

In embodiments, system 100 further comprises an illumination unit 160 (e.g. a spot projection device), arranged to illuminate objects 97B according to the identified gaze direction and/or the identified finger pointing direction; or according to the identified gaze direction and/or the identified finger pointing direction with respect to display 90, for example with respect to a displayed element 97A relating to object 97B (e.g. an icon or image thereof). Processor 110 may be arranged to calculate a correspondence between a virtual location of elements 96 of 97A on display 90 and an actual location of associated object 97B and direct illumination unit 160 to object 97B accordingly. Object 97B may be remote from display 90, e.g. system 100 may be used to operate or illuminate objects in remote locations.

Generally, illumination unit 160 may be arranged to illuminate at least one of: an object in the detected gaze direction, an object in the identified pointing direction, an object corresponding to a displayed element in the detected gaze direction, and an object corresponding to a displayed element in the identified pointing direction. In embodiments, illumination unit 160 may be arranged to carry out the illumination upon the indication of alignment of the detected gaze direction and the identified pointing direction.

Upon detection of a pointing activity of a user (i.e., alignment of gaze and finger direction), processor 110 may instruct display 90 to highlight the object (e.g. 97A or 97B) that was selected by the pointing activity. The selected object may be an item on the screen or a physical object that is visible to the imaging sensors of the system.

In some embodiments, the system may be networked with two or more users who can thus communicate with each other through a communication infrastructure such as the Internet. In a multi user environment, embodiments allow one user to highlight It also may be required for a user to highlight an object at the other user system or a physical object that is visible to the imaging sensors of the other user system.

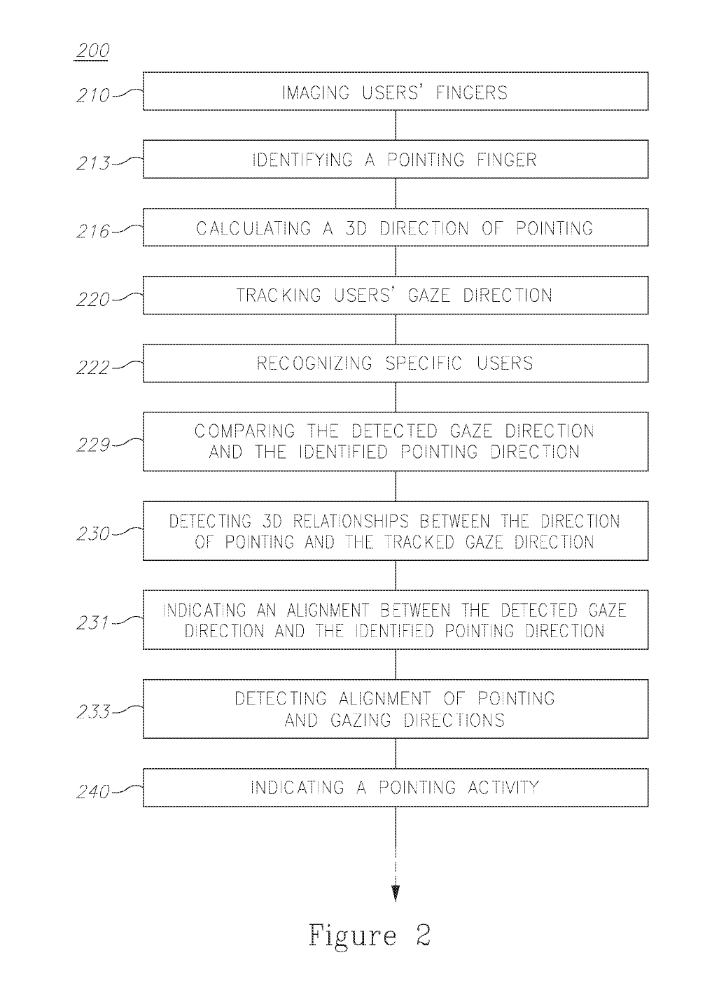

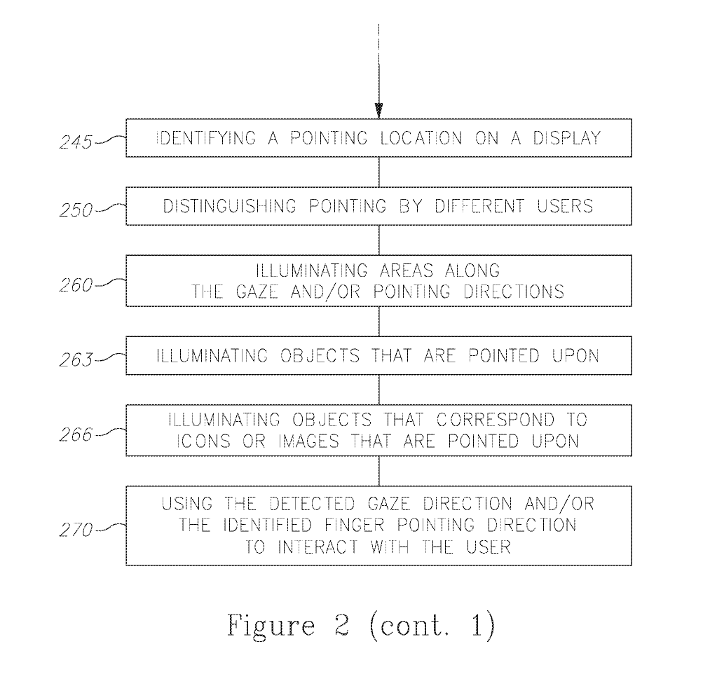

FIG. 2 is a high level flowchart illustrating a method 200, according to some embodiments of the invention. Method 200 or any of its stages may be at least partially implemented by computer readable programs, and be at least partially carried out by at least one computer processor (in a non-limiting example, processor 110).

Method 200 may comprise the following stages: detecting or tracking a direction of a user's gaze (stage 220), e.g. with respect to a single user or multiple users, identifying a user's pointing finger (stage 213), e.g. by imaging users' fingers (stage 210) and identifying a pointing finger, and a corresponding finger pointing direction (stage 216), e.g. by calculating a 3D direction of pointing.

In embodiments, method 200 may comprise recognizing specific users (stage 222) with respect to either or both gazing direction and pointing direction and differentiating among the users, e.g. by distinguishing pointing by different users (stage 250). In embodiments, method 200 may further comprise recognizing different users and differentiating between their respective gazes.

Method 200 may comprise indicating a pointing activity by the user (stage 240) and, for example, identifying a pointing location on a display (stage 245), with relation to either the gazing or the finger pointing, or to both ways of pointing and their spatial relationships.

Method 200 may further comprise comparing the detected gaze direction and the identified pointing direction (stage 229), e.g. by detecting 3D relationships between the direction of pointing and the tracked gaze direction (stage 230) and indicating an alignment between the detected gaze direction and the identified pointing direction (stage 231), e.g. after detecting alignment of pointing and gazing directions (stage 233).

In embodiments, method 200 may further comprise using at least one of the detected gaze direction and the identified finger pointing direction to interact with the user (stage 270).

In embodiments, method 200 may further comprise illuminating areas along the gaze and/or pointing directions (stage 260), illuminating objects that are pointed upon (stage 263) and illuminating objects that correspond to icons or images that are pointed upon (stage 266). Generally, method 200 may comprise illuminating at least one of: an object in the detected gaze direction, an object in the identified pointing direction, an object corresponding to a displayed element in the detected gaze direction, and an object corresponding to a displayed element in the identified pointing direction. The illumination may be carried out upon the indication of alignment of the detected gaze direction and the identified pointing direction.

Embodiments of the invention comprise a computer program product comprising a computer readable storage medium having computer readable program embodied therewith, which may comprise computer readable program configured to detect a direction of a user's gaze; computer readable program configured to identify a user's pointing finger and a corresponding finger pointing direction; computer readable program configured to compare the detected gaze direction and the identified pointing direction; and computer readable program configured to indicate an alignment between the detected gaze direction and the identified pointing direction. The computer program product may further comprise computer readable program configured to recognize different users and differentiating between their respective gazes and computer readable program configured to serve as a user interface that uses at least one of the detected gaze direction and the identified finger pointing direction to interact with the user. Computer program product may further comprise computer readable program configured to implement any of the stages of method 200 or elements of system 100.

System 100 and method 200 improve on prior art NUIs and may be used for different kinds of interfaces. The presented interface may identify objects, real or virtual, that are pointed at by users, and also distinguish between different users pointing at different objects. This interface may be implemented between users and computers, or between multiple users, co-located or communicating e.g. over the internet. The interface may be applied for operating computing and communication devices, for interacting with other users, for gaming etc.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system comprising:
a gaze tracking device arranged to detect a direction of a user's gaze;
a three dimensional (3D) imaging device arranged to identify a user's pointing finger and a corresponding finger pointing direction; and
a processor arranged to compare the detected gaze direction and the identified pointing direction and indicate an alignment therebetween within a predefined tolerance.

2. The system of claim 1, further comprising a face recognition module arranged to recognize different users and differentiate between their respective gazes.

3. The system of claim 1, further comprising a user interface arranged to use at least one of the detected gaze direction and the identified finger pointing direction to interact with the user.

4. The system of claim 1, further comprising an illumination unit arranged to illuminate at least one of: an object in the detected gaze direction, an object in the identified pointing direction, an object corresponding to a displayed element in the detected gaze direction, and an object corresponding to a displayed element in the identified pointing direction.

5. The system of claim 4, wherein the illumination unit is arranged to carry out the illumination upon the indication of alignment of the detected gaze direction and the identified pointing direction.

6. A method comprising:
detecting a direction of a user's gaze;
identifying a user's pointing finger and a corresponding finger pointing direction;
comparing the detected gaze direction and the identified pointing direction; and
indicating an alignment between the detected gaze direction and the identified pointing direction,
wherein at least one of: the detecting, the identifying, the comparing and the indicating is carried out by at least one computer processor.

7. The method of claim 6, further comprising recognizing different users and differentiating between their respective gazes.

8. The method of claim 6, further comprising using at least one of the detected gaze direction and the identified finger pointing direction to interact with the user.

9. The method of claim 6, further comprising illuminating at least one of: an object in the detected gaze direction, an object in the identified pointing direction, an object corresponding to a displayed element in the detected gaze direction, and an object corresponding to a displayed element in the identified pointing direction.

10. The method of claim 9, further comprising carrying out the illumination upon the indication of alignment of the detected gaze direction and the identified pointing direction.

11. A computer program product comprising a computer readable storage medium having computer readable program embodied therewith, the computer readable program comprising:
computer readable program configured to detect a direction of a user's gaze;
computer readable program configured to identify a user's pointing finger and a corresponding finger pointing direction;
computer readable program configured to compare the detected gaze direction and the identified pointing direction; and
computer readable program configured to indicate an alignment between the detected gaze direction and the identified pointing direction,

12. A computer program product of claim 11, further comprising computer readable program configured to recognize different users and differentiating between their respective gazes.

13. A computer program product of claim 11, further comprising computer readable program configured to serve as a user interface that uses at least one of the detected gaze direction and the identified finger pointing direction to interact with the user.
